(19) United States
(12) Patent Application Publication
(10) Pub. No.: US 2003/0217617 A1
(43) Pub. Date: Nov. 27, 2003

(54) Transmission

(76) Inventors: Hiroshi Sakamoto, Hitachi (JP); Toshimichi Minowa, Mito (JP); Takashi Okada, Hitachi (JP); Mitsuo Kayano, Fukuoka (JP); Tatsuya Ochi, Tokai (JP)

Correspondence Address: CROWELL & MORING LLP, INTELLECTUAL PROPERTY GROUP, P.O. BOX 14300, WASHINGTON, DC, 20044-4300, US

(21) Appl. No.: 10/247,653

(22) Filed: Sep. 20, 2002

(30) Foreign Application Priority Data
May 22, 2002 (JP) 2002-147065

(51) Int. Cl. F16H 37/06

(52) U.S. Cl. 74/665 B; 74/661

(57) ABSTRACT

In a transmission, a transmission stage is formed by a mating pair of a first driving gear rotationally fixed to an input shaft and a first driven gear mounted on an output shaft in a rotatable manner and releasably connectable rotationally to the output shaft by a first clutch, and another transmission stage is formed by another mating pair of a second driving gear rotationally fixed to a supplemental shaft and a second driven gear mounted on the output shaft in a rotatable manner and releasably connectable rotationally to the output shaft by a second clutch while the supplemental shaft is rotationally driven by the input shaft by a supplemental gear rotationally fixed to the supplemental shaft and mating with the first driven gear.

### BACKGROUND OF THE INVENTION AND RELATED ART STATEMENT

The present invention relates to a transmission for transmitting an output power of an engine connected to an input shaft thereof to an output shaft thereof with a selected one of transmission ratios (transmission ratio is a ratio of a rotational amount or velocity of the output shaft to the rotational amount or velocity of an input shaft).

In a transmission for hybrid automobile as disclosed by JP-A-9-156388, an input shaft and an output shaft are releasably connectable to each other by a clutch, and a motor-generator is incorporated into the transmission.

In a transmission as disclosed by JP-A-2001-227599, a friction clutch transmits a torque between input and output shafts with a slip in such a manner that a time period of no-torque transmission therebetween is prevented from occurring.

### OBJECT AND SUMMARY OF THE INVENTION

An object of the present invention is to provide a transmission for transmitting an output power of an engine connected to an input shaft thereof to an output shaft thereof with a desirably selected one of transmission ratios, suitable for incorporating a motor-generator into the transmission.

According to the present invention, in a transmission for transmitting an output power of an engine with a selected one of transmission ratios, comprising an input shaft connectable to the engine to take the output power thereof into the transmission, an output shaft for outputting the output power from the transmission, a first driving gear rotationally fixed to the input shaft, a first driven gear mating with the first driving gear to be driven by the first driving gear and mounted in a rotatable manner on the output shaft, and a first clutch for releasably connecting the first driven gear to the output shaft so that the output shaft is driven by the input shaft through the first driving and driven gears,

the transmission further comprises, a supplemental shaft operable to transmit the output power from the input shaft to the output shaft through the supplemental shaft, a supplemental gear mating with the first driven gear to be driven by the input shaft through the first driving and driven gears and connected rotationally to the supplemental shaft so that the supplemental shaft is driven by the input shaft through the first driving and driven gears, a second driving gear mounted on the supplemental shaft, a second driven gear mating with the second driving gear to be driven by the second driving gear and mounted on the output shaft, and a second clutch for releasably connecting one of the second driving and driven gears to one of the output and supplemental shafts on which the one of the second driving and driven gears is mounted in a rotatable manner so that the output shaft is driven by the input shaft through the one of the second driving and driven gear and another one of the second driving and driven gears rotationally fixed to another one of the output and supplemental shafts (other than the one of the output and supplemental shafts) when the first clutch is prevented from connecting rotationally the first driven gear to the output shaft.

Since a transmission ratio between the input and output shafts is formed by a pair of the first driving and driven gears, and another transmission ratio between the input and output shafts (different from the transmission ratio) is formed by a pair of the first driving gear and the supplemental gear and a pair of the second driving and driven gears, a number of gears to be mounted on the input shaft for a plurality of the transmission ratios is decreased so that a length of the input shaft for mounting the gear(s) thereon is decreased. Therefore, a motor-generator can be arranged within a region through which an axis of the input shaft passes and/or to which the gear(s) on the input shaft faces in a direction of the axis of the input shaft, without increasing a whole length of the transmission in the direction of the axis of the input shaft.

When the transmission further comprises, a third driving gear mounted on the supplemental shaft, a third driven gear mating with the third driving gear and mounted on the output shaft, and a third clutch for transmitting a torque adjustably between one of the third driving and driven gears and second one of the supplemental and output shafts on which the one of the third driving and driven gears is mounted in a rotatable manner so that the output shaft is driven by the input shaft through the one of the third driving and driven gears and another one of the third driving and driven gears rotationally fixed to another second one of the output and supplemental shafts (other than the second one of the supplemental and output shafts) at least when the first clutch is prevented from connecting rotationally the first driven gear to the output shaft and the second clutch is prevented from connecting rotationally the one of the second driving and driven gears to the one of the output and supplemental shafts, a distance between the third clutch and the input shaft is made great to expand the region within which the motor-generator is arranged.

The third clutch may be a slip clutch capable of transmitting the torque with a rotational slip between the one of the third driving and driven gears and the second one of the supplemental and output shafts also when the first clutch connects rotationally the first driven gear to the output shaft or the second clutch connects rotationally the one of the second driving and driven gears to the one of the output and supplemental shafts, so that a time period of no-torque transmission from the input shaft to the output shaft between two of the predetermined transmission stages or ratios is prevented from occurring.

If a first lubrication oil for lubricating the third clutch is fluidly isolated from a second lubrication oil for lubricating the gears, both a frictional characteristic of the first lubrication oil for transmitting the torque with the rotational slip between the one of the third driving and driven gears and the second one of the supplemental and output shafts and a non frictional characteristic of the second lubrication oil for lubricating the gears mating each other are kept at respective desirable degrees independent of each other.

When the transmission further comprises a motor-generator connected to the input shaft to drive the input shaft when an electric power is supplied into the motor-generator and to generate the electric power to be taken out of the motor-generator when the motor-generator is driven by the input shaft, a planetary gear device may be connected to the input shaft and the motor-generator in series. The motor-generator may drive the input shaft when a combustion of the internal combustion engine is started. The motor-generator may drive the input shaft to change an output torque of the output shaft when the engine stops rotationally or the motor-generator assists the operating engine. The motor-generator may drive the input shaft to adjust a rotational speed of the input shaft when the connection between the first driven gear and the output shaft is changed by the first clutch so that an abrupt change in rotational speed of the input shaft caused by a disengage or engage between the first driven gear and the output shaft by the first clutch is restrained.

If an output shaft of the motor-generator is parallel to at least one of the input and output shafts, and an imaginary plane passing through the second driving and driven gears and being perpendicular to the at least one of the input and output shafts traverses the motor-generator, an axial length is transmission is kept small. More preferably, the imaginary plane traverses an electromagnetic coil of the motor-generator.

When a motor is connected to the input shaft so that the input shaft is driven by the motor when an electric power is supplied into the motor, it is preferable for keeping a radial size of the transmission small that a part of the first driving gear (or a part of a minimum radial size gear when a plurality of gears are mounted on the input shaft) and the motor overlap each other as seen in a direction along an axis of the input shaft.

The transmission may further comprise an additional driving gear mounted on the supplemental shaft, an additional driven gear mating with the additional driving gear to be driven by the additional driving gear and mounted on the output shaft, an additional clutch for releasably connecting one of the additional driving and driven gears to corresponding one of the output and supplemental shafts on which the one of the additional driving and driven gears is mounted in a rotatable manner so that the output shaft is driven by the input shaft through the one of the additional driving and driven gear and another one of the additional driving and driven gears rotationally fixed to another corresponding one of the output and supplemental shafts (other than the corresponding one of the output and supplemental shafts) when the first clutch is prevented from connecting rotationally the first driven gear to the output shaft and the second clutch is prevented from connecting rotationally the one of the second driving and driven gears to the one of the output and supplemental shafts. When an output shaft of the motor-generator is parallel to at least one of the input and output shafts, it is preferable for keeping the axial length of the transmission small that an imaginary plane passing through the second driving and driven gears and being perpendicular to the at least one of the input and output shafts and an imaginary plane passing through the additional driving and driven gears and being perpendicular to the at least one of the input and output shafts traverse the motor-generator. More preferably, the imaginary planes traverse an electromagnetic coil of the motor-generator.

If an extension of an axis of the input shaft passes an area surrounded by electromagnetic coils of the motor generator as seen in a direction along the axis of the input shaft, the radial size of the transmission is kept small.

If the second clutch connects the one of the second driving and driven gears to the one of the output and supplemental shafts so that the output shaft is driven by the input shaft when the first clutch is prevented from connecting rotationally the first driven gear to the output shaft and the third clutch is prevented from transmitting the torque between the one of the third driving and driven gears and the second one of the supplemental and output shafts, the supplemental shaft is used to transmit the torque not only for preventing the time period of no-torque transmission from the input shaft to the output shaft between two of the predetermined transmission stages or ratios, but also for performing at least one of the predetermined transmission stages or transmission ratios, so that a number of the transmission stages or transmission ratios formed by pairs of mating gears in each pair of which mating gears one of the gears is mounted on the input shaft, that is, a number of gears to be mounted on the input shaft is decreased (most desirably to one or possibly to two in five transmission stages) to form or increase a space for receiving the motor generator close to the input shaft.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic cross-sectional view showing an embodiment of transmission of the invention with a torque assist mechanism as shown by dot line.

FIG. 2 is a schematic side cross-sectional view showing the embodiment of transmission of the invention.

FIG. 3 includes schematic front and side views showing a vehicle in which the embodiment of transmission of the invention is arranged.

FIG. 4 is a cross-sectional enlarged view showing the torque assist mechanism.

FIG. 5 includes diagrams showing a relationship between time proceeding and torque value transmitted by dog-clutch, a relationship between time proceeding and torque value transmitted by assist(slip)-clutch, and a relationship between time proceeding and a total torque value transmitted by dog-clutch and assist(slip)-clutch.

FIG. 6 is a schematic cross-sectional view showing another embodiment of transmission of the invention with a motor-generator.

FIG. 7 is a schematic cross-sectional view showing another embodiment of transmission of the invention with the torque assist mechanism and the motor-generator.

FIG. 8 is a schematic cross-sectional view showing another embodiment of transmission of the invention with the motor-generator and a planetary gear device connecting the motor-generator and the input shaft in series.

FIG. 9 is a schematic cross-sectional view showing another embodiment of transmission of the invention with the torque assist mechanism and the motor-generator coaxial with the input shaft.

FIG. 10 is a schematic cross-sectional view showing another embodiment of transmission of the invention with the motor-generator and twin-clutches between the input shaft and an engine.

FIG. 11 is a schematic cross-sectional view showing another embodiment of transmission of the invention with the motor-generator, the twin-clutches between the input shaft and the engine, and the planetary gear device connecting the motor-generator to the input shaft.

### DETAILED DESCRIPTION OF PREFERRED EMBODIMENTS

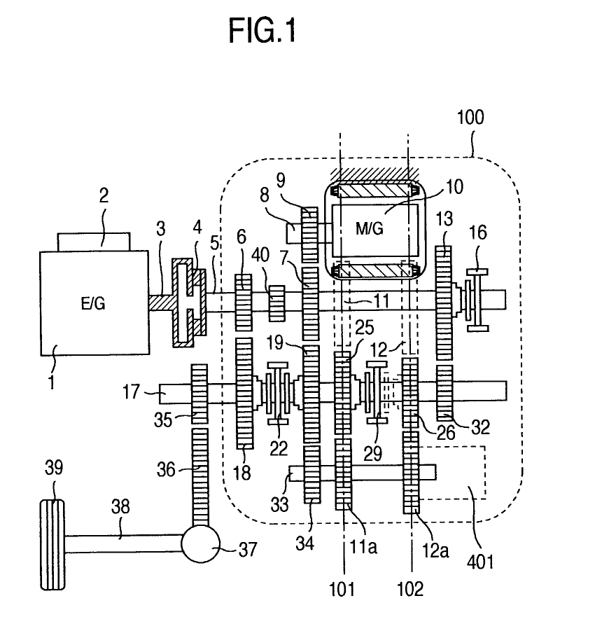

As shown in FIG. 1, an automatic transmission 100 is contained by a transmission case. In an (internal combustion) engine 1, a flow rate of an intake air is measured by an electronically controlled throttle 2 mounted on an intake air tube (not shown), and a fuel amount corresponding to the flow rate of the intake air is injected from a fuel injector (not shown). An ignition timing is determined on the basis of a fuel-air ratio calculated from the intake air flow rate and the fuel amount and an engine rotational speed measured by an engine rotational speed sensor (not shown), and the ignition is performed by an ignition device (not shown). In a type of the fuel injector, the fuel is injected into the intake air tube, and in another type of the fuel injector, the fuel is injected directly into a combustion cylinder. Which type is used is determined by taking an operation range of the engine (desirable engine torque range, desirable engine rotational speed range or the like) into consideration in such a manner that a fuel consumption is decreased and an exhaust characteristic is improved.

An output shaft 3 of the engine 1 is connected to an input shaft 5 of the automatic transmission 100 through a torque transmission mechanism (clutch) 4. A rotatable output shaft 17 extends parallel to the input shaft 5 on which a first transmission stage drive gear 6, a second transmission stage drive gear 7, a fifth transmission stage drive gear 13 and a reverse gear 40. A third transmission stage drive gear 11a and a fourth transmission stage drive gear 12a are mounted on a supplemental shaft 33. The first transmission stage drive gear 6 and the second transmission stage drive gear 7 are rotationally fixed to the input shaft 5, and the fifth transmission stage drive gear 13 is rotatable on the input shaft 5. The third transmission stage drive gear 11a and the fourth transmission stage drive gear 12a are rotationally fixed to the supplemental shaft 33.

A first transmission stage driven gear 18, a second transmission stage driven gear 19, a third transmission stage driven gear 25, a fourth transmission stage driven gear 26 and a fifth transmission stage driven gear 32 are mounted on the output shaft 17. The first transmission stage driven gear 18 and the second transmission stage driven gear 19 mating respectively with the first transmission stage drive gear 6 and the second transmission stage drive gear 7 on the input shaft 5 are rotatable on the output shaft 17. The supplemental shaft 33 is rotationally driven by the input shaft 5 through the second transmission stage drive gear 7, the second transmission stage driven gear 19 and a supplemental gear 34 mating with the second transmission stage driven gear 19 and rotationally fixed to the supplemental shaft 33. The third transmission stage driven gear 25 and the fourth transmission stage driven gear 26 mating respectively with the third transmission stage drive gear 11a and the fourth transmission stage drive gear 12a on the supplemental shaft 33 are rotatable on the output shaft 17. The fifth transmission stage driven gear 32 mating with the fifth transmission stage drive gear 13 on the input shaft 5 is rotationally fixed to the output shaft 17.

A dog clutch 16 rotationally fixed to and movable axially on the input shaft 5 releasably connects rotationally the fifth transmission stage drive gear 13 to the input shaft 5 so that the output shaft 17 is driven through the fifth transmission stage drive and driven gears 13 and 32 by the input shaft 5. A dog clutch 22 rotationally fixed to and movable axially on the output shaft 17 releasably connects rotationally the first transmission stage driven gear 18 to the output shaft 17 so that the output shaft 17 is driven through the first transmission stage drive and driven gears 6 and 18 by the input shaft 5 when the dog clutch 22 is shifted to a left side, and releasably connects rotationally the second transmission stage driven gear 19 to the output shaft 17 so that the output shaft 17 is driven through the second transmission stage drive and driven gears 7 and 19 by the input shaft 5 when the dog clutch 22 is shifted to a right side. A dog clutch 29 rotationally fixed to and movable axially on the output shaft 17 releasably connects rotationally the third transmission stage driven gear 25 to the output shaft 17 so that the output shaft 17 is driven through the third transmission stage drive and driven gears 11a and 25 by the input shaft 5 when the dog clutch 29 is shifted to a left side, and releasably connects rotationally the fourth transmission stage driven gear 26 to the output shaft 17 so that the output shaft 17 is driven through the fourth transmission stage drive and driven gears 12a and 26 by the input shaft 5 when the dog clutch 22 is shifted to a right side. The fifth transmission stage drive gear 16 is rotationally stationary when the dog clutch 16 is positioned at its neutral position. The first transmission stage driven gear 18, second transmission stage driven gear 19, third transmission stage driven gear 25 and fourth transmission stage driven gear 26 are rotationally stationary when the dog clutches 22 and 29 are positioned at respective central or neutral positions.

The dog clutches 16, 22 and 29 are operated by an actuator of a shift select mechanism (not shown) which selects one of transmission ratios of first-fifth transmission stages on the basis of a pressed amount of an accelerator pedal, a vehicle speed, and a transmission stage order from a driver.

A motor generator 10 for driving the input shaft 5 when an electric power is supplied into the motor-generator 10 and generating the electric power to be taken out of the motor-generator when the motor-generator 10 is driven by the input shaft 5 is connected rotationally to the input shaft 5 through a motor generator gear 9 mating with the second transmission stage drive gear 7. An output shaft 8 of the motor generator 10 is parallel to the input shaft 5. The motor generator 10 generates a torque to drive the vehicle when the engine stops or to assist an acceleration of vehicle when the engine operates, and generates the electric power to be taken out of the motor-generator when the vehicle is decelerated by the motor generator 10. The motor generator 10 may be rotationally connected to the input shaft 5 by belt drive or chain drive.

If the motor generator 10 is arranged in such a manner that an imaginary plane 101 passing through the third transmission stage drive and driven gear 11a and 25 and an imaginary plane 102 passing through the fourth transmission stage drive and driven gear 12a and 26 both perpendicular to the input shaft 5 traverse the motor generator 10, an axial length and a radial size of the transmission is kept small although the motor generator 10 is incorporated therein.

Each of tires 39 is driven by the output shaft 17 through a drive shaft 38, a differential gear 37 for distributing a torque between left and right tires 39, and a pair of final drive gears 35 and 36 mating each other.

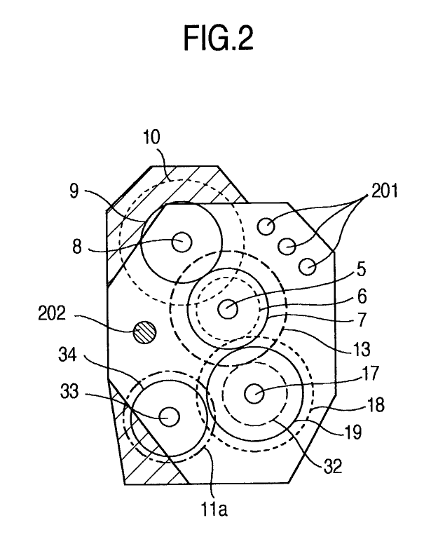

As shown in FIG. 2, a rod 202 of the shift select mechanism and an reverse idle shaft 202 on which an idle gear for the reverse gears is rotatably supported are opposite to each other through the input shaft 5, and the motor generator 10 is arranged between the rod 202 and the idle shaft 202. The supplemental shaft 33 and the reverse idle shaft 202 may be arranged coaxially or formed integrally. The motor generator 10 is arranged in such a manner that the motor generator 10 and at least one (preferably minimum diameter one) of the first transmission stage drive gear 6, second transmission stage drive gear 7 and fifth transmission stage drive gear 13 overlap each other as seen in a direction along the axis of the input shaft 5. The motor generator 10 is arranged between the second transmission stage drive gear 7 and the fifth transmission stage drive gear 13 in the axial direction. In FIG. 2, hatched areas are additional areas for containing additionally the motor generator in the transmission. Since the hatched areas are small in comparison with the prior art size of the transmission without the motor generator contained in the transmission, the transmission of the invention can be incorporated easily into the automobile now on sale.

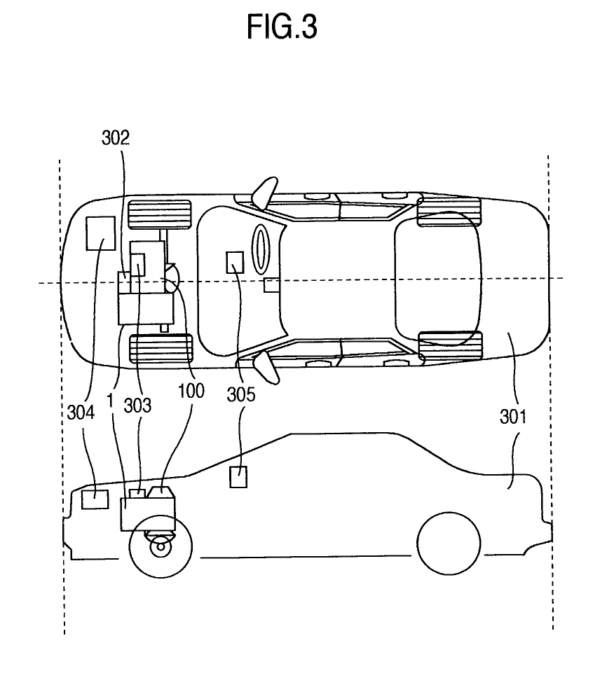

As shown in FIG. 3, the transmission 100 is mounted in a space adjacent to the engine 1 between front tires of a vehicle body 301 with a drive mechanism 302 of the clutch 4, a shift selector mechanism 303, a hydraulic unit for the drive mechanism 302 and shift selector mechanism 303, and an indicator 305.

When a range lever is positioned at a parking (P) position or neutral (N) position and a driver switches on an ignition switch, whether or not the engine should be started is determined in accordance with a condition of a battery. When a usable remaining capacity of the battery is less than a predetermined value, the battery needs to be charged electrically and an operation of the engine is started by rotating the engine with the motor generator 10 connected rotationally to the input shaft 5 to be driven by the clutch 4. When the usable remaining capacity of the battery is not less than the predetermined value, the operation of the engine is not started to keep an idling stop thereof.

When the range lever is shifted from the parking (P) position or neutral (N) position to a drive (D) position and the idling stop of the engine is kept, the clutch 4 is released by the drive mechanism 302 and the shift selector mechanism 303 moves the dog clutch 22 from the neutral or central position to the left side thereof to rotationally connect the first transmission stage driven gear 18 to the output shaft 17 so that the output shaft 17 is rotationally driven by the input shaft 5 through the first transmission stage drive and driven gears 6 and 18. The torque of the output shaft 17 is transmitted to the tires 39 through the final drive and driven gears 35 and 36, the differential gear 37 and the drive shaft 38. At this situation, when the driver releases a brake pedal to order a creep or low acceleration run of the vehicle, the release of the clutch 4 is kept and the motor generator 10 drives the output shaft 17. Thereafter, the driver presses the accelerator pedal further to order a high acceleration run of the vehicle, the engine 1 is started and the drive mechanism 302 increases gradually a torque transmission of the clutch 4 to accelerate the vehicle with a torque of the engine 1.

When the brake pedal is pressed to keep the vehicle stationary and the usable remaining capacity of the battery is less than the predetermined value so that the engine is not in the idling stop, in order to electrically charge the battery, the clutch 4 is prevented from being released so that the engine 1 drives the motor generator 10 while the dog clutches 22 and 29 are positioned at the neutral positions respectively when the range lever is at the parking (P) position or neutral (N) position, and even when the range lever is at the drive (D) position. At this situation, if the range lever is shifted from the parking (P) position or neutral (N) position to the drive (D) position and the driver releases the brake pedal to order the creep or low acceleration run of the vehicle, the clutch 4 is released by the drive mechanism 302 and the shift selector mechanism 303 moves the dog clutch 22 from the neutral or central position to the left side thereof to rotationally connect the first transmission stage driven gear 18 to the output shaft 17 so that the output shaft 17 is rotationally driven by the input shaft 5 through the first transmission stage drive and driven gears 6 and 18. Subsequently, the clutch 4 connects rotationally the engine 1 to the input shaft 5 with a rotational slip therebetween so that the output shaft 17 is driven by the engine 1 to start a proceeding of the vehicle for the creep or low acceleration run of the vehicle. Thereafter, if the driver presses the accelerator pedal further to order a high acceleration run of the vehicle, the rotational slip between the input shaft 5 and the engine 1 by the clutch 4 is gradually decreased.

If the driver presses the brake pedal to decelerate the vehicle, the dog clutch 22 or 29 maintain the rotational connection between the input shaft 5 and the output shaft 17 to drive the motor generator 10 by the output shaft 17 so that the motor generator 10 generates an electric power to be stored in the battery by decelerating or braking the input shaft 5 by the motor generator 10.

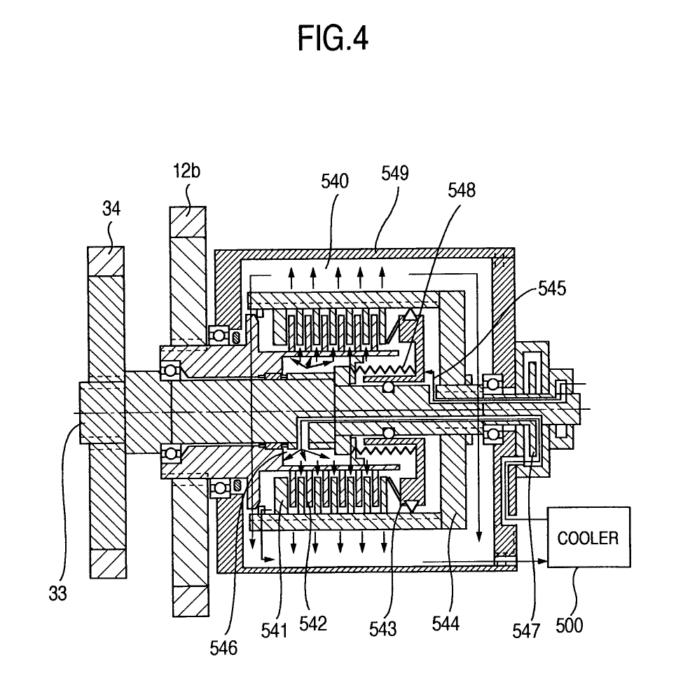

If a torque assist mechanism 401 (shown by a dot line in FIG. 1) is connected to the supplemental shaft 33 while the dog clutch 29 is modified in such a manner that the dog clutch 29 is capable of releasably connecting rotationally only the third transmission stage driven gear 25 to the output shaft 17 but prevented from connecting rotationally the fourth transmission stage driven gear 26 to the output shaft 17, the fourth transmission stage drive gear 12a rotationally fixed to the supplemental shaft 33 is replaced by a fourth transmission stage drive gear 12b mounted in a rotatable manner on the supplemental shaft 33 and mating with the fourth transmission stage driven gear 26, the fourth transmission stage driven gear 26 rotatable on the output shaft 17 is modified in such a manner that the fourth transmission stage driven gear 26 is rotationally fixed to the output shaft 17. As shown in FIG. 4, the fourth transmission stage drive gear 12b is rotationally connected releasably and in a transmitting torque adjustable manner to the supplemental shaft 33 by the torque assist mechanism 401 so that the output shaft 17 is driven by the input shaft 5 with a rotational slip therebetween through the fourth transmission stage drive and driven gears 12b and 26 and the torque assist mechanism 401.

The torque assist mechanism 401 includes a set of axially movable drive plates 541 rotationally fixed to the supplemental shaft 33, a set of axially movable driven plates 542 rotationally fixed to the fourth transmission stage drive gear 12b while the drive plates 541 and driven plates 542 are axially stacked alternately in such a manner that they can be pressed axially against each other, and a casing 549 containing therein the drive plates 541 and driven plates 542 and a torque assist mechanism lubricant oil for keeping a frictional condition between the drive plates 541 and driven plates 542 constant.

The torque assist mechanism lubricant oil circulates in the torque assist mechanism 401 by being radially and circumferentially urged by the rotation of the driven plates 542, the supplemental shaft 33 and the drive plates 541, being stored in a bottom of the casing 549, being cooled by a cooler 500, being pumped by an oil pump 547, passing through a lubrication oil path 546 in the supplemental shaft 33, and passing between the drive plates 541 and driven plates 542 in a clutch drum 544.

The drive plates 541 and driven plates 542 are pressed axially against each other by a hydraulic piston 543 driven by a hydraulic pressure supplied from a hydraulic oil passage 545 in the supplemental shaft 33. A value of the torque transmitted between the drive plates 541 and driven plates 542, that is, between the output shaft 17 and the input shaft 5 through the torque assist mechanism 401, is determined in accordance with a pressing force applied between the drive plates 541 and driven plates 542, and the torque is transmitted between the drive plates 541 and driven plates 542 with a rotational slip therebetween. When the hydraulic pressure for driving the hydraulic piston 543 is released, the hydraulic piston 543 is prevented by a return spring 548 from pressing axially the drive plates 541 and driven plates 542 against each other so that the output shaft 17 is prevented from being driven by the input shaft 5 through the fourth transmission stage drive and driven gears 12b and 26.

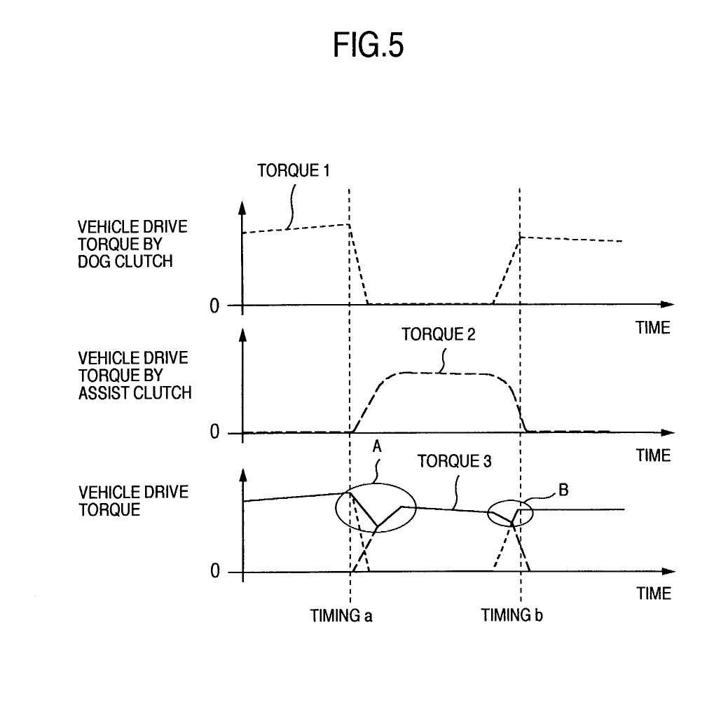

As shown in FIG. 5, during a time period after one of the transmission stages is released at a timing a by positioning both of the dog clutches 22 and 29 to the neutral positions respectively to prevent the torque transmission between the input shaft 5 and the output shaft 17 through the dog clutches 22 and 29 and before another of the transmission stages is formed at a timing b by positioning one of the dog clutches 22 and 29 to the left or right side to perform the torque transmission between the input shaft 5 and the output shaft 17 through the one of the dog clutches 22 and 29, the torque is not transmitted between the input shaft 5 and the output shaft 17 through the dog clutches 22 and 29.

The torque assist mechanism 401 as the claimed third clutch transmits the torque between the input shaft 5 and the output shaft 17 with the rotational slip therebetween during the time period of no torque transmission as described above. Since the torque assist mechanism 401 transmits the torque between the input shaft 5 and the output shaft 17 with the rotational slip therebetween, the torque assist mechanism 401 can transmit the torque between the input shaft 5 and the output shaft 17 even when one of the dog clutches 22 and 29 is positioned at the left or right side or is not positioned completely to the neutral position thereof to perform the torque transmission between the input shaft 5 and the output shaft 17 through the one of the dog clutches 22 and 29 as shown by torque 1 and torque 2 in FIG. 5. Therefore, the torque as a total amount of the torque value transmitted by the one of the dog clutches 22 and 29 and the torque value transmitted by the torque assist mechanism 401 can be transmitted continuously between the input shaft 5 and the output shaft 17 without the time period of no torque transmission as shown by torque 3 in FIG. 3, so that an abrupt change of rotational speed or acceleration of the output shaft 17 is restrained. When the fourth transmission stage is formed, the rotational slip of the torque assist mechanism 401 is kept as small as possible or prevented completely. After one of the dog clutches 22 and 29 is positioned completely at the left or right side, the torque transmission through the torque assist mechanism 401 may be decreased or prevented.

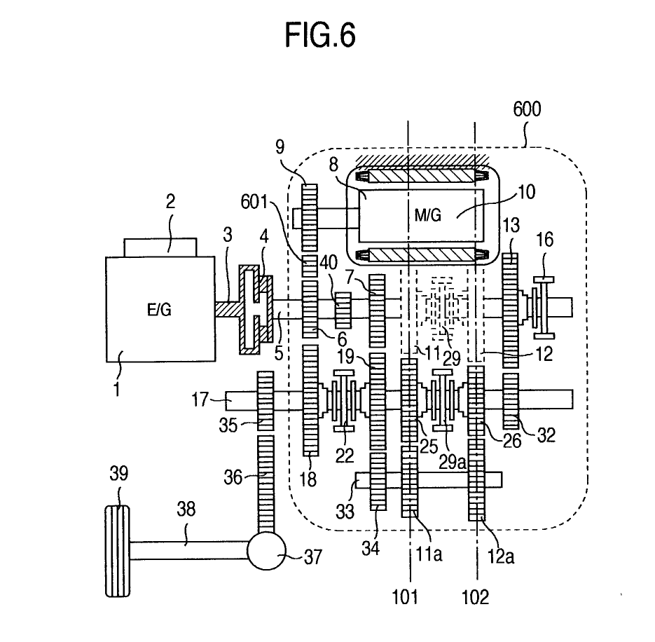

In an automatic transmission 600 of embodiment as shown in FIG. 6, the motor generator 10 has a relatively long axial length greater than an axial distance between the second transmission stage drive gear 7 and the fifth transmission stage drive gear 13. Therefore, the motor generator 10 is arranged at a radially outside of the second transmission stage drive gear 7 in such a manner that an imaginary plane passing through the third transmission stage drive and driven gears 11a and 25 and perpendicular to the output shaft 17 or the input shaft 5 and/or an imaginary plane passing through the fourth transmission stage drive and driven gears 12a and 26 and perpendicular to the output shaft 17 or the input shaft 5 passes the motor generator 10, more preferably an electromagnetic coil of the motor generator 10. The fifth transmission stage drive gear 13 and the motor generator 10 overlap each other as seen in a direction along the axis of the input shaft 5.

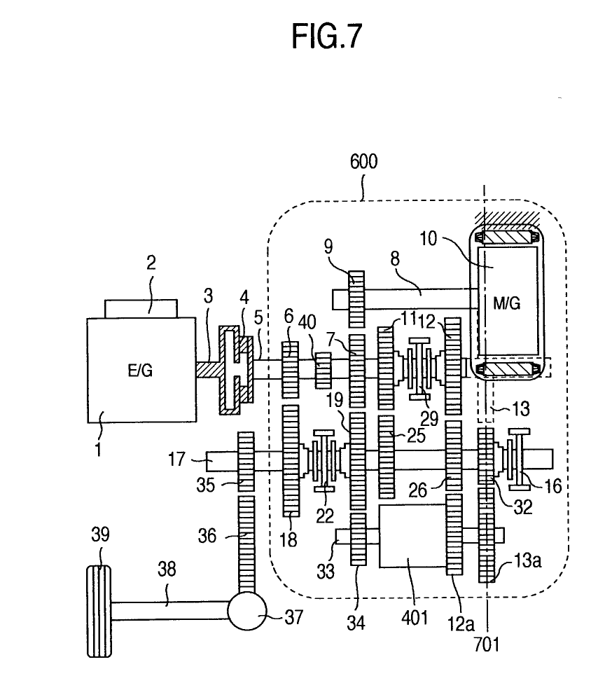

In an automatic transmission 700 of embodiment as shown in FIG. 7, the motor generator 10 has a relatively great radial size. A third transmission stage drive gear 11 and a fourth transmission stage drive gear 12 are mounted in a rotatable manner on the input shaft 5 and the dog clutch 29 rotationally fixed to and movable axially on the input shaft 5 releasably connects rotationally the third transmission stage drive gear 11 to the input shaft 5 so that the output shaft 17 is driven through the third transmission stage drive and driven gears 11 and 25 by the input shaft 5 when the dog clutch 29 is shifted to a left side, and releasably connects rotationally the fourth transmission stage drive gear 12 to the input shaft 5 so that the output shaft 17 is driven through the fourth transmission stage drive and driven gears 12 and 26 by the input shaft 5 when the dog clutch 22 is shifted to a right side. The third transmission stage driven gear 25 and fourth transmission stage driven gear 26 mating respectively with the third transmission stage drive gear 11 and fourth transmission stage driven gear 12 are rotationally fixed to the output shaft 17.

The torque assist mechanism 401 is mounted on the supplemental shaft 33, and the fourth transmission stage drive gear 12b mounted in a rotatable manner on the supplemental shaft 33 mating with the fourth transmission stage driven gear 2 is rotationally connectable to the supplemental shaft 33 by the torque assist mechanism 401. The torque assist mechanism 401 transmits the torque from the input shaft 5 to the output shaft 17 when the dog clutches 16, 22 and 29 are not completely positioned at the right or left side or are at the neutral position, and is prevented from transmitting the torque from the input shaft 5 to the output shaft 17 when one of the dog clutches 16, 22 and 29 is completely positioned at the right or left side. Incidentally, the torque assist mechanism 401 may transmit the torque from the input shaft 5 to the output shaft 17 during a short time after the one of the dog clutches 16, 22 and 29 is completely positioned at the right or left side. Since a torque transmission efficiency of the dog clutch is superior to that of a slip clutch such as the torque assist mechanism 401, it is preferable for the transmission stage is formed by the dog clutch rather than the slip clutch.

The fifth transmission stage drive gear 13a is rotationally fixed to the supplemental shaft 33, and the fifth transmission stage driven gear 32 is mounted in a rotatable manner on the output shaft 17 and is releasably connectable rotationally to the output shaft 17 by the dog clutch 16 to be driven by the input shaft 5. An imaginary plane 701 passing the fifth transmission stage drive and driven gears 13a and 32 and perpendicular to the output shaft 17 or the input shaft 5 transverses the motor generator 10, more particularly, the electromagnetic coil thereof. All of the gears mounted on the input shaft 5 and the motor generator 10 overlap each other as seen in the direction along the axis of the input shaft 5, and at least a part of the input shaft 5 and the motor generator 10 overlap each other as seen in the direction along the axis of the input shaft 5.

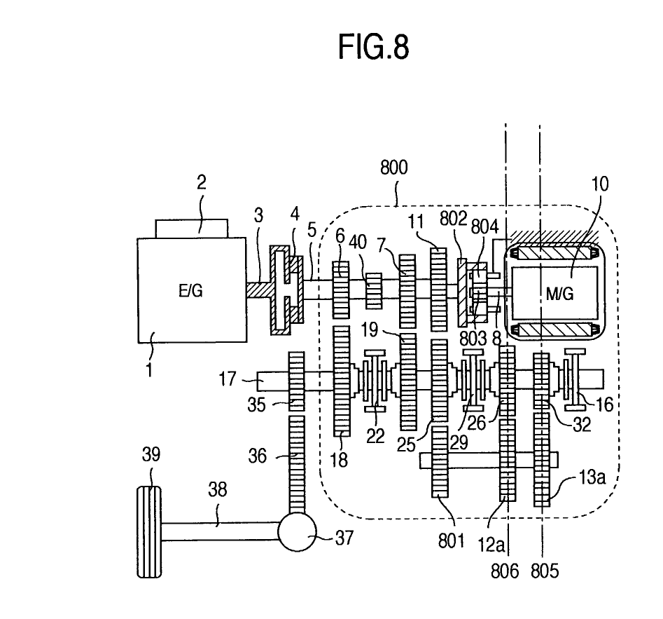

In an automatic transmission 800 of embodiment as shown in FIG. 8, the supplemental shaft 33 is driven by the input shaft through a supplemental gear 801 rotationally fixed to the supplemental shaft 33 and the third transmission stage driven gear 25 mounted in a rotatable manner on the output shaft 17 and releasably connectable rotationally to the output shaft 17 by the dog clutch 29 to drive the output shaft 17, and the fourth transmission stage drive gear 12a and the fifth transmission stage drive gear 13a are mounted on the supplemental shaft 33 to decrease an axial length of the input shaft 5. The motor generator 10 is rotationally connected to the input shaft 5 through a planetary gear device including a ring gear 802, a sun gear 802 and planetary gears 804. The ring gear 802 is rotationally fixed to the input shaft 5 and mates with the planetary gears 804, and the sun gear 802 mates with the planetary gears 804 and rotationally fixed to the output shaft 8 of the motor generator 10 to drive the ring gear 802 by the output shaft 8. An imaginary plane 805 passing the fifth transmission stage drive and driven gears 13a and 32 and perpendicular to the output shaft 17 or the input shaft 5 and/or an imaginary plane 806 passing through the fourth transmission stage drive and driven gear 12a and 26 and perpendicular to the output shaft 17 or the input shaft 5 transverse the motor generator 10. The axis of the input shaft 5 and the axis of the output shaft 8 of the motor generator are coaxial, and all of the gears mounted on the input shaft 5 and the motor generator 10 overlap each other as seen in the direction along the axis of the input shaft 5.

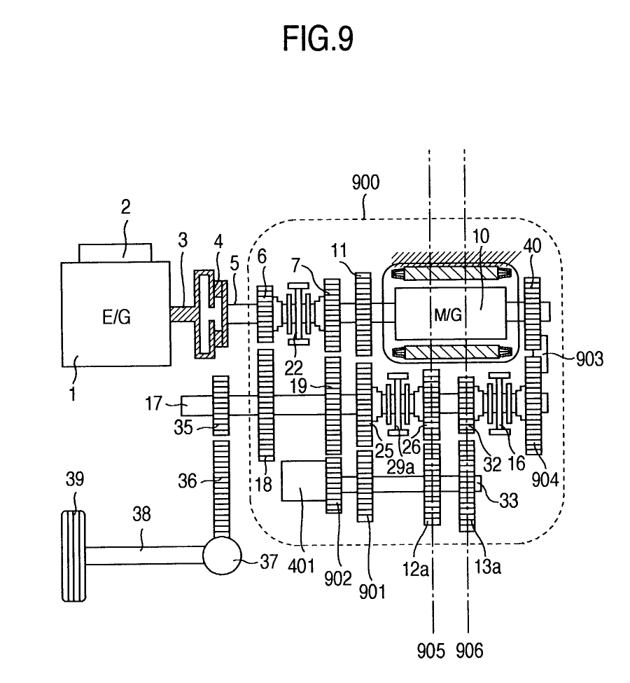

In an automatic transmission 900 of embodiment as shown in FIG. 9, the motor generator 10 is coaxially mounted on the input shaft 5, the first transmission stage drive gear 6 and second transmission stage drive gear 7 mounted in a rotatable manner on the input shaft 5 are releasably connectable rotationally to the input shaft by the dog clutch 22, and the first transmission stage driven gear 18 mating with the first transmission stage drive gear 6 and the second transmission stage driven gear 19 mating with the second transmission stage drive gear 7 are rotationally fixed to the output shaft 17. A reverse gear 40 rotationally fixed to the input shaft 5 mates with a reverse idle gear 903 rotatable on a reverse idle shaft to drive the output shaft 17 through a reverse driven gear 904 mating with the reverse idle gear 903, mounted in a rotatable manner on the output shaft and releasably connectable rotationally to the output shaft 17 by the dog clutch 16.

The supplemental gear 901 mating with the third transmission stage driven gear 25 rotatable on the output shaft and releasably connectable rotationally to the output shaft 17 by the dog clutch 29, the fourth transmission stage drive gear 12a mating with the fourth transmission stage driven gear 26, the fifth transmission stage drive gear 13a mating with the fifth transmission stage driven gear 32 are rotationally fixed to the supplemental shaft 33, and a assist gear 902 mating with the second transmission stage driven gear 19 rotationally fixed to the output shaft 17 is mounted in a rotatable manner on the supplemental shaft 33 and connectable rotationally to the supplemental shaft by the torque assist mechanism 401.

Since it is desirable for decreasing an axial length of the torque assist mechanism 401 that a diameter of the torque assist mechanism 401 is kept as large as possible, the torque assist mechanism 401 is arrange in an axial space between the first transmission stage driven gear 18 and the second transmission stage driven gear 19 without the dog clutch. The motor generator 10 may be arranged in an axial space between the third transmission stage drive gear 11 and the reverse gear 40 when a reduction gear device does not need to connect the motor generator 10 and the input shaft 5 to each other. An imaginary plane 906 passing through the fifth transmission stage drive and driven gear 13a and 32 and/or an imaginary plane 905 passing through the fourth transmission stage drive and driven gear 12a and 26 both perpendicular to the input shaft 5 traverse the motor generator 10, so that a sympathetic vibrations of the shafts caused by a vibration of the engine output shaft 3 and/or tires 39 is restrained. All of the gears mounted on the input shaft 5 and the motor generator 10 overlap each other as seen in the direction along the axis of the input shaft 5.

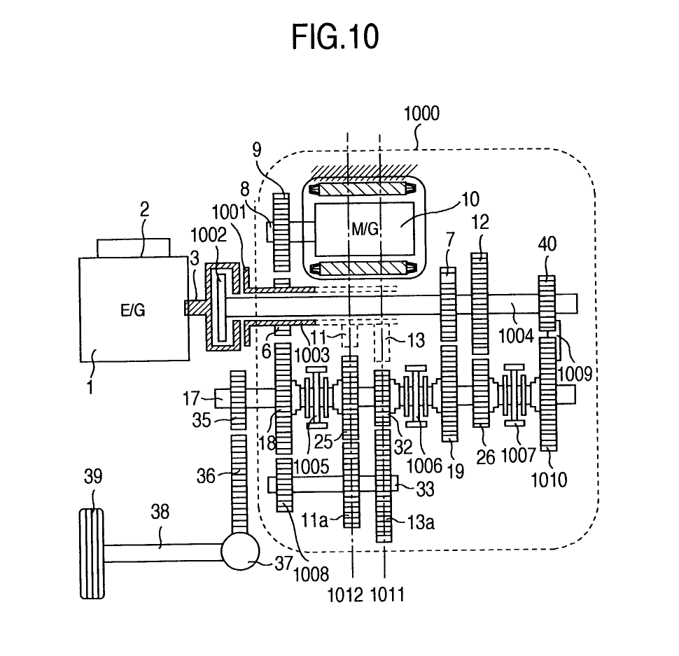

In an automatic transmission 1000 of embodiment as shown in FIG. 10, a first input shaft 1003 is releasably connectable rotationally to the output shaft 3 by a first clutch 1001 and a second input shaft 1004 is releasably connectable rotationally to the output shaft by a second clutch 1002. The first input shaft 1003 and second input shaft 1004 are rotatable with respect to each other and coaxial with the output shaft 3. The first transmission stage drive gear 6 mating with the first transmission stage driven gear 18 is rotationally fixed to the first input shaft 1003, and the second transmission stage drive gear 7, fourth transmission stage drive gear 12 and reverse drive gear 40 are rotationally fixed to the second input shaft 1004. The third transmission stage drive gear 11a and fifth transmission stage drive gear 13a are rotationally fixed to the supplemental shaft 33 driven by a supplemental gear 1008 rotationally fixed to the supplemental shaft 33 and mating with the first transmission stage driven gear 18 rotatable on the output shaft 33 and the first transmission stage drive gear 6 mating with the first transmission stage driven gear 18. Dog clutches 1005, 1006, 1007 releasably connect rotationally the first transmission stage driven gear 18, second transmission stage driven gear 19, third transmission stage driven gear 25, fifth transmission stage driven gear 32, fourth transmission stage driven gear 26 and reverse driven gear 1010 rotatable on the output shaft 17 respectively to the output shaft 17 to form respective transmission stages with the first transmission stage drive gear 6, second transmission stage drive gear 7, third transmission stage drive gear 11a and fifth transmission stage drive gear 13a, fourth transmission stage drive gear 12 and reverse drive gear 40 respectively. The reverse driven gear 1010 is driven through a rotatable reverse idle gear 1009 by the reverse drive gear 40.

The motor generator 10 is received in an axial space between the first transmission stage drive gear 6 and the second transmission stage drive gear 7, and is rotationally connected to the input shaft 1003 through the motor generator gear 9 mating with the first transmission stage drive gear 6. An imaginary plane 1012 passing through the third driving and driven gears 11a and 25 and being perpendicular to the input or output shaft and/or an imaginary plane passing through the fifth driving and driven gears 13a and 32 and being perpendicular to the input or output shaft traverse the motor-generator. At least one of the second transmission stage drive gear 7, fourth transmission stage drive gear 12 and reverse drive gear 40 may be mounted on or rotationally fixed to the supplemental shaft 33 instead of the input shaft 1004. The motor generator 10 may be connected rotationally to the input shaft 1004.

At least a part of the second transmission stage drive gear 7 and/or fourth transmission stage drive gear 12 may overlap the motor generator 10 as seen in the direction along the axis of the input shaft.

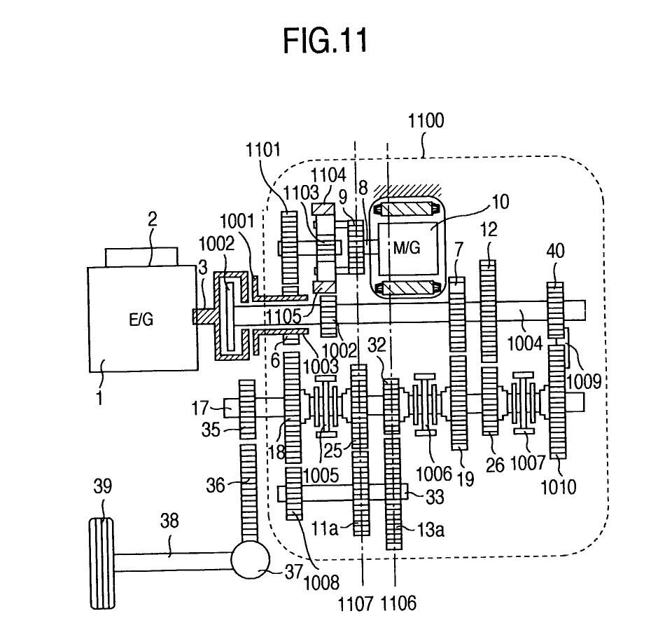

In an automatic transmission 1100 of embodiment as shown in FIG. 11, the motor generator 10 is rotationally connected to the first and second input shaft 1003 and 1004 through a planetary gear device including a ring gear 1105, a sun gear 1103 and planetary gears 1104. Outer teeth of the ring gear 1105 mate with a gear 1102 rotationally fixed to the input shaft 1104, inner teeth thereof mate with the planetary gears 1104 mating with the sun gear 1103 and driven orbitally by the output shaft 8 of the motor generator 10 to drive the ring gear 1105 through the planetary gears 1104, and the sun gear 1103 is rotationally connected to a gear 1101 mating with the first transmission stage drive gear 6, so that a difference in rotational speed between the first and second input shaft 1003 and 1004 is adjusted or decreased by the motor generator 10 to smoothly change the transmission stage by the dog clutch.

An imaginary plane 1106 passing the fifth transmission stage drive and driven gears 13a and 32 and perpendicular to the input shaft 1003 or 1004 and/or output shaft 17 and/or an imaginary plane 1107 passing through the fourth transmission stage drive and driven gear 12a and 26 and perpendicular to the input shaft 1003 or 1004 and/or output shaft 17 transverse the motor generator 10 and/or the planetary gear device. A part of the second transmission stage drive gear 7 and/or fourth transmission stage drive gear 12 and the motor generator 10 overlap each other as seen in the direction along the axis of the input shaft 5.

The following substances of inventions other than the claimed inventions are also covered by the embodiments as described above.

An automatic transmission comprises an input shaft being capable of receiving a driving force from an engine and having an input shaft gear(s), an output shaft for outputting the driving force after being converted, a gear mounted on the output shaft in a rotatable manner, a third shaft being capable of being rotationally driven by the input shaft through the gear and having a plurality of transmission stage gears corresponding to respective transmission stages, and an electric motor for generating another driving force to be transmitted to the output shaft, which electric motor and a minimum diameter one of input shaft gear(s) overlap each other as seen in an axial direction of the input shaft,

wherein the output shaft has a plurality of output shaft gears engaged respectively with the transmission stage gears to selectively drive the output shaft with a selected one of the transmission stages.

Another automatic transmission comprises an input shaft being capable of receiving a driving force from an engine, an output shaft for outputting the driving force after being converted, a plurality of output shaft gears mounted on the output shaft in a rotatable manner, a clutch device for connecting rotationally selected one of the output shaft gears to the output shaft, and a third shaft being capable of being rotationally driven by the input shaft through one of the output shaft gears and having a plurality of transmission stage gears corresponding to respective transmission stages so that each of the transmission stage gears engages with respective one of the output shaft gear,

wherein a torque transmission device mounted on the third shaft and capable of transmitting the driving force from the input shaft to the output shaft even when a change from one of the transmission stages to another of transmission stages occurs, that is, a time period between the one of the transmission stages and the another or subsequent one of transmission stages.

Another automatic transmission comprises an input shaft being capable of receiving a driving force from an engine and having a input shaft gear, an output shaft for outputting the driving force after being converted, a gear mounted on the output shaft in a rotatable manner, a third shaft being capable of being rotationally driven by the input shaft through the gear and having a plurality of transmission stage gears corresponding to respective transmission stages, a plurality of output shaft gears mounted on the output shaft so that each of the transmission stage gears engages with respective one of the output shaft gear, and an electric motor for generating another driving force to be transmitted to the output shaft, which electric motor and the input shaft gear overlap each other as seen in an axial direction of the input shaft,

wherein the automatic transmission further comprises a torque transmission device mounted on the third shaft and capable of transmitting the driving force from the input shaft to the output shaft even when a change from one of the transmission stages to another of transmission stages occurs, that is, a time period between the one of the transmission stages and the another or subsequent one of transmission stages.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A transmission for transmitting an output power of an engine with a selected one of transmission ratios, comprising,
an input shaft connectable to the engine to take the output power thereof into the transmission,
an output shaft for outputting the output power from the transmission,
a first driving gear rotationally fixed to the input shaft,
a first driven gear mating with the first driving gear to be driven by the first driving gear and mounted in a rotatable manner on the output shaft, and
a first clutch for releasably connecting the first driven gear to the output shaft so that the output shaft is driven by the input shaft through the first driving and driven gears, wherein the transmission further comprises,
a supplemental shaft operable to transmit the output power from the input shaft to the output shaft through the supplemental shaft,
a supplemental gear mating with the first driven gear to be driven by the input shaft through the first driving and driven gears and connected rotationally to the supplemental shaft so that the supplemental shaft is driven by the input shaft through the first driving and driven gears,
a second driving gear mounted on the supplemental shaft,
a second driven gear mating with the second driving gear to be driven by the second driving gear and mounted on the output shaft, and
a second clutch for releasably connecting one of the second driving and driven gears to one of the output and supplemental shafts on which the one of the second driving and driven gears is mounted in a rotatable manner so that the output shaft is driven by the input shaft through the one of the second driving and driven gear and another one of the second driving and driven gears rotationally fixed to another one of the output and supplemental shafts when the first clutch is prevented from connecting rotationally the first driven gear to the output shaft.

2. A transmission according to claim 1, wherein the transmission further comprises,
a third driving gear mounted on the supplemental shaft,
a third driven gear mating with the third driving gear and mounted on the output shaft, and
a third clutch for transmitting a torque between one of the third driving and driven gears and second one of the supplemental and output shafts on which the one of the third driving and driven gears is mounted in a rotatable manner so that the output shaft is driven by the input shaft through the one of the third driving and driven gears and another one of the third driving and driven gears rotationally fixed to another second one of the output and supplemental shafts at least when the first clutch is prevented from connecting rotationally the first driven gear to the output shaft and the second clutch is prevented from connecting rotationally the one of the second driving and driven gears to the one of the output and supplemental shafts.

3. A transmission according to claim 2, wherein the third clutch is a slip clutch capable of transmitting the torque with a rotational slip between the one of the third driving and driven gears and the second one of the supplemental and output shafts.

4. A transmission according to claim 3, wherein the third clutch is capable of transmitting the torque between the one of the third driving and driven gears and the second one of the supplemental and output shafts when the first clutch connects rotationally the first driven gear to the output shaft.

5. A transmission according to claim 3, wherein the third clutch is capable of transmitting the torque between the one of the third driving and driven gears and the second one of the supplemental and output shafts when the second clutch connects rotationally the one of the second driving and driven gears to the one of the output and supplemental shafts.

6. A transmission according to claim 3, wherein a first lubrication oil for lubricating the third clutch is fluidly isolated from a second lubrication oil for lubricating the gears.

7. A transmission according to claim 1, wherein the transmission further comprises a motor-generator connected to the input shaft to drive the input shaft when an electric power is supplied into the motor-generator and to generate the electric power to be taken out of the motor-generator when the motor-generator is driven by the input shaft.

8. A transmission according to claim 7, wherein the transmission further comprises a planetary gear device through which the motor-generator is connected to the input shaft.

9. A transmission according to claim 7, wherein the motor-generator drives the input shaft when a combustion of the engine is started.

10. A transmission according to claim 7, wherein the motor-generator drives the input shaft to change an output torque of the output shaft.

11. A transmission according to claim 7, wherein the motor-generator drives the input shaft to adjust a rotational speed of the input shaft when the connection between the first driven gear and the output shaft is changed by the first clutch.

12. A transmission according to claim 7, wherein an output shaft of the motor-generator is parallel to at least one of the input and output shafts, and an imaginary plane passing through the second driving and driven gears and being perpendicular to the at least one of the input and output shafts traverses the motor-generator.

13. A transmission according to claim 12, wherein the imaginary plane traverses an electromagnetic coil of the motor-generator.

14. A transmission according to claim 1, wherein the transmission further comprises a motor connected to the input shaft to drive the input shaft when an electric power is supplied into the motor, and the motor and a part of the first driving gear overlap each other as seen in a direction along an axis of the input shaft.

15. A transmission according to claim 7, wherein the transmission further comprises an additional driving gear mounted on the supplemental shaft,
an additional driven gear mating with the additional driving gear to be driven by the additional driving gear and mounted on the output shaft,
an additional clutch for releasably connecting one of the additional driving and driven gears to corresponding one of the output and supplemental shafts on which the one of the additional driving and driven gears is mounted in a rotatable manner so that the output shaft is driven by the input shaft through the one of the additional driving and driven gear and another one of the additional driving and driven gears rotationally fixed to another corresponding one of the output and supplemental shafts when the first clutch is prevented from connecting rotationally the first driven gear to the output shaft and the second clutch is prevented from connecting rotationally the one of the second driving and driven gears to the one of the output and supplemental shafts.

16. A transmission according to claim 15, wherein an output shaft of the motor-generator is parallel to at least one of the input and output shafts, an imaginary plane passing through the second driving and driven gears and being perpendicular to the at least one of the input and output shafts and an imaginary plane passing through the additional driving and driven gears and being perpendicular to the at least one of the input and output shafts traverse the motor-generator.

17. A transmission according to claim 16, wherein the imaginary planes traverse an electromagnetic coil of the motor-generator.

18. A transmission according to claim 7, wherein an extension of an axis of the input shaft passes an area surrounded by electromagnetic coils of the motor generator as seen in a direction along the axis of the input shaft.

19. A transmission according to claim 2, wherein the second clutch connects the one of the second driving and driven gears to the one of the output and supplemental shafts so that the output shaft is driven by the input shaft when the first clutch is prevented from connecting rotationally the first driven gear to the output shaft and the third clutch is prevented from transmitting the torque between the one of the third driving and driven gears and the second one of the supplemental and output shafts.

20. A transmission according to claim 2, wherein the third clutch is mounted on the third driving gear to transmit the torque between the third driving gear and the supplemental shaft.
